(19) United States
(12) Patent Application Publication
(10) Pub. No.: US 2018/0244455 A1
(43) Pub. Date: Aug. 30, 2018

(54) FALSE EYELASH DISPLAY SCALE

(71) Applicant: Yongho Han, Great Neck, NY (US)

(72) Inventor: Yongho Han, Great Neck, NY (US)

(21) Appl. No.: 15/443,477

(22) Filed: Feb. 27, 2017

(51) Int. Cl. B65D 77/26; B65D 77/20; G01B 3/00

(52) U.S. Cl. CPC B65D 77/26; A41G 5/02; G01B 3/004; B65D 77/20

(57) ABSTRACT

A label device for displaying a false eyelash is disclosed. The label has a length which corresponds to the cooperating false eyelash, and has a scale thereon for showing the measure of the eyelash. The label further has a tab, which tab extends from the top edge of the label and is for displaying the measure of the label. The label has adhesive on its back side, but adhesive does not extend up the tab. The label is for being adhered to a cooperating substrate, which substrate is a protrusion which extends upwardly from a tray. Also disclosed is a method of using the label.

### BACKGROUND OF THE INVENTION

### Field of the Invention

The present invention relates to a(n) device for aiding in display of false eyelashes, and more particularly, a FALSE EYELASH DISPLAY SCALE.

### Description of the Prior Art

Numerous innovations for false eyelash displays have been provided in the prior art that will be described. Even though these innovations may be suitable for the specific individual purposes to which they address, however, they differ from the present invention.

A FIRST EXAMPLE, U.S. Pat. No. 2,667,176, Published/Issued on Jan. 26, 1954, to Wassmer teaches an applicator device whereby artificial eyelashes of both types may be easily and quickly applied by a user to her own eyelashes. A feature of the applicator is an arrangement of structure making it possible to successively sever and dispense individual eyelash lengths of hair or treated thread from a continuous supply of same, and to positively control such lengths during the stage of application, all manually, to the end that the procedure is rendered deft and sure for each and every user.

A SECOND EXAMPLE, U.S. Pat. No. 3,333,593, Published/Issued on Aug. 1, 1967, to McGivern teaches a container for storing a false eyelash and for maintaining the hairs of the-false eyelash in a desired profile, said container comprising: a bottom having a groove adapted to receive said false eyelash, the groove having a profile substantially matching the profile to be imparted to the hairs of said eyelash, and a top having a transparent protuberance shaped to fit complementally within said groove when the container is closed, such that a false eyelash within said groove can be simultaneously stored, curled, and viewed when the container is closed.

A THIRD EXAMPLE, U.S. Pat. No. 3,416,655, Published/Issued on Dec. 17, 1968, to Shiffman teaches a display box which not only incorporates a pivoted internal tray, but in which the tray is formed in a special manner, enabling the insertion of a velvet-covered type material, the box incorporating a base member and a cover, each of which at its rear flanges is provided with a channel to receive an elongated bead at the rear end of the tray, a spring-clip passing through the tray inwardly of its bead and engaging two in-cut seats provided one for the body member and one for the cover. When the cover is opened, the spring-clip holds it in such position, and when the cover is closed the spring-clip keeps it in such closed position. The bottom wall of the box base member is provided with a centrally disposed inverted protrusion, which is open at its base and has opposed side Walls formed with pintle receiving recesses adapted for a movable easel having spaced arms, each with a pintle for one of said recesses.

A FOURTH EXAMPLE, U.S. Pat. No. 8,424,542, Published/Issued on Apr. 23, 2013, to Han teaches An integral cosmetic eye-enhancer and applier facilitating donning of the cosmetic eye-enhancer by holding the applier by the fingertips of a user generally horizontally so as to have to bend the wrist of the user but not have to squeeze the applier by the fingertips of the user when donning the cosmetic eye-enhancer. A pair of applicator trays are replaceably contained within a storage container. A pair of false eyelashes are releasibly attached to corresponding working ends of the pair of applicator trays, respectively. The other corresponding ends of the pair of applicator trays are held by the fingertips of the user generally horizontally so as to have to bend the wrist of the user but not have to squeeze the other corresponding ends of the pair of applicator trays by the fingertips of the user when donning the pair of false eyelashes.

A FIFTH EXAMPLE, U.S. Pat. No. 8,573,233, Published/Issued on Nov. 5, 2013, to Chen teaches A cosmetic container with a transparent window has a main base, a cover with the transparent window and mounted on the main base, a lateral movement base mounted between the main base and the cover, a longitudinal movement base mounted on the main base and a transmission element connecting to the lateral and longitudinal movement bases. The transparent window allows a user to recognize kinds and colors of cosmetics that are mounted on the lateral movement base therethrough. When the transmission element is driven by the longitudinal movement base, the transmission element drives the lateral movement base consequently to push the lateral and longitudinal movement bases outwardly. Thus, it is easy to open or close the cosmetic container with only one hand.

A SIXTH EXAMPLE, U.S. Pat. No. 8,701,685, Published/Issued on Apr. 22, 2014, to Chipman teaches An eyelash extension system includes an extension strip with a backing and a plurality of eyelash extensions. Each extension has a proximal end and a distal end. The proximal end of each extension is joined to the backing and distal end of each extension extends away from the backing. The system also includes an extension tray with at least one curved extension attachment surface to receive the extension strip such that adhering the extension strip to the curved extension attachment surface spreads the distal ends of the extensions farther apart than the proximal ends of the extensions joined to the backing.

A SEVENTH EXAMPLE, U.S. Pat. No. 9,044,077, Published/Issued on Jun. 2, 2015, to Lin teaches an eyelash holder includes a base and at least one eyelash mount disposed on the base. The at least one eyelash mount includes an eyelash positioning edge and at least one holding means disposed on the eyelash positioning edge. The at least one holding means includes a first end connecting to the eyelash positioning edge and a second end separating from the eyelash positioning edge with an eyelash holding space.

AN EIGHTH EXAMPLE, U.S. Patent Office Document No. D215,821, Published/Issued on Nov. 4, 1969, to Howard teaches a display package of false eyelashes and adhesive material

A NINTH EXAMPLE, U.S. Patent Office Document No. 20100116425, Published/Issued on May 13, 2010, to KONSTI, et al. teaches a linerless stack of adhesive labels comprising a plurality of labels, each label comprising a sheet having front face and rear face and a layer of pressure sensitive adhesive on only a portion of the rear face, each label having a separable tab portion and label portion is provided. Also, a method for labeling an article comprising: providing a linerless stack of labels; providing an article; removing the uppermost label from the stack by lifting or pull on its tab portion so as to cause the adhesive on the uppermost label to separate from the front face of the underlying label; then positioning the removed label in desired position on an article; adhering the label to the article with the adhesive; and separating the tab portion of the label from the label portion of the label.

A TENTH EXAMPLE, U.S. Patent Office Document No. 20130312782, Published/Issued on Nov. 28, 2013, to Kindall teaches an eyelash extension pallet for use in applying eyelash extensions and method of applying eyelash extensions

AN ELEVENTH EXAMPLE, U.S. Patent Office Document No. 20140110304, Published/Issued on Apr. 24, 2014, to Wu, et al. teaches an eyelash case is adapted for containing a plurality of false eyelashes, and includes a case body and a handle plate. The case body includes abase and a cover plate that is disposed above the base and that is connected to the base to define an accommodating space therebetween. Each of the base and the cover plate has a transparent region. The transparent regions of the base and the cover plate are aligned with each other, and are adapted to permit the false eyelashes to be positioned therebetween. The handle plate is connected to the case body, and is misaligned from the transparent regions of the base and the cover plate.

It is apparent now that numerous innovations for eyelash display have been provided in the prior art that adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a FALSE EYELASH DISPLAY SCALE that avoids the disadvantages of the prior art.

ANOTHER OBJECT of the present invention is to provide a FALSE EYELASH DISPLAY SCALE that is simple and inexpensive to manufacture.

STILL ANOTHER OBJECT of the present invention is to provide a FALSE EYELASH DISPLAY SCALE that is simple to use. BRIEFLY STATED, STILL YET ANOTHER OBJECT of the present invention is to provide a FALSE EYELASH DISPLAY SCALE that corresponds in size to the eyelash displayed to prevent misuse or misidentification.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWINGS

The figures of the drawings are briefly described as follows:

FIG. 1 is a diagrammatic perspective view illustrating an embodiment the FALSE EYELASH DISPLAY SCALE in use in a point of sale display package;

FIG. 2 is a diagrammatic perspective view illustrating an example of the FALSE EYELASH DISPLAY SCALE, with a false eyelash attached thereto;

FIG. 3 is a front elevational view of just a typical display scale per se; and

FIG. 4 is a rear elevational view thereof.

### A MARSHALING OF REFERENCE NUMERALS UTILIZED IN THE DRAWINGS

10 display device
12 label
14 adhesive
16 false eyelash
18 length of label 12
20 length of false eyelash 16
22 tray substrate
24 scale of label 12
26 front side of label 12
28 back side of label 12
30 length of scale 24 of label 12
32 tab of label 12
34 top of label 12
36 bottom of label 12
38 length of tab 32 of label 12
40 indicia of tab 32 of label 12
42 protrusion of tray substrate 22
44 cover of tray substrate 22
46 shape of false eyelash 16
48 component lash of false eyelash 16

### DETAILED DESCRIPTION OF THE PREFERRED EMBODIMENT

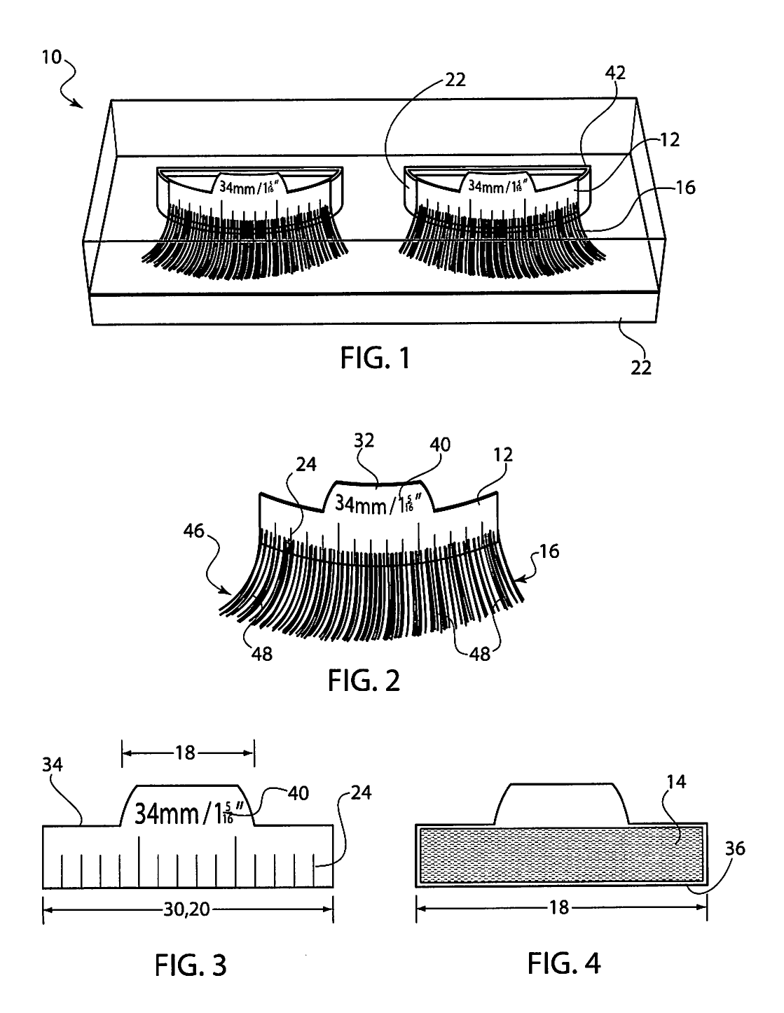

Referring now to the figures, in which like numerals indicate like parts, and particularly to FIG. 1, disclosed is a display device 10 which has:

a) a label 12; and

b) an adhesive 14.

The label 12 is for displaying a cooperating false eyelash 16. The label 12 has a length 18. The cooperating false eyelash 16 has a length 20, typically but not limited to 24 mm to 34 mm. That length of the cooperating false eyelash 16 is the length extending from the furthermost two lashes from one another. The length 18 of the label 12 corresponds to the length 20 of the cooperating false eyelash 16. The adhesive 14 is for securing the label 12 to a substrate 22. This structure permits a user to see that a false eyelash 16 is of a length corresponding to the length of the label 12 and assure that they are obtaining the correct size for their eye. This avoids the problem many users face where they purchase false eyelashes 16 of inappropriate size and cut them to size, which cutting can alter the shape of the false eyelash 16. As most clearly seen in FIG. 2, false eyelashes 16 often have a differential length of lash depending on the eye in which they are meant to rest.

Further to the same purpose, the label 12 further has a scale 24. The label 12 has a front side 26 and a back side 28. The scale 24 is disposed on the front side 26 of the label 12. The adhesive 14 is disposed on the back side 28. The scale 24 has a length 30 corresponding to the length 20 of the cooperating false eyelash 16 and to the length 18 of the label 18. This structure prevents mis-using the label with an incorrect false eyelash 16 by assuring that the physical bounds of the false eyelash 16 match the marked scale 24.

As illustrated best in FIGS. 3 and 4, the label further has a tab 32. The label 12 has a top 34 and a bottom 36. The top 34 and the bottom 36 run along the length 18 of the label 12. The tab 32 extends from the top 34 of the label 12. The tab 32 has a length 38. The length 38 of the tab 32 is less than the length 18 of the label 12.

The adhesive 14 is disposed on the back side 28 of the label 12, but is not disposed on the tab 32. This allows the tab to stick up from the tray substrate 22 and provide an enhanced visibility to the measure, without leaving exposed adhesive. The tab 32 contains indicia 40 indicating the length 18 of the label 12.

As illustrated in FIG. 1, the substrate 22 is a tray having at least one protrusion 42 thereon, which protrusion 42 is for displaying the false eyelash 16. The tray 22 has a cover 44. The cover 44 is sufficiently raised above the at least one protrusion 42 so that the tab 32 of the label 12 is not contacted by the cover 44 when the cover 44 is closed. In order to allow easy release of the cooperating false eyelash, the front side 26 of the label is impermeable to fluids.

In the preferred embodiment, and as illustrated in FIG. 2, and in furtherance of the aforementioned goals concerning preventing cutting of false eyelashes 16, the cooperating false eyelash 16 has a shape 46. The shape 46 of the cooperating false eyelash 16 is formed by the varying lengths of component lashes 48 of the cooperating false eyelash 16.

Additionally now disclosed is a method of utilizing the display device 10 wherein the display device 10 has:

i) a label 12; and

ii) an adhesive 14.

The display device 10 is for displaying a false eyelash 16. The display device 10 is for being attached to a cooperating substrate 22. The label 12 has a front side 26 and a back side 28. The front side 26 of the label has a scale 24. The adhesive 14 is on the back side 28 of the label 12. The label 12 may be fabricated out of an opaque, translucent or clear transparent material as chosen by the manufacturer.

The method has the steps of:
a) aligning the false eyelash 16 with the scale 24 of the front side 26 of the label 12;
b) securing the false eyelash 16 to the front side 26 of the label 12;
c) exposing the adhesive 14 of the label 12; and
d) adhering the label 12 to the substrate 22 with the adhesive 14.

It will be understood that each of the elements described above, or two or more together, may also find a useful application in other types of constructions differing from the types described above.

While the invention has been illustrated and described as embodiments of a FALSE EYELASH DISPLAY SCALE, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A display device which comprises:
a) a label; and
b) an adhesive;
wherein said label is for displaying a cooperating false eyelash;
wherein said label has a length;
wherein said cooperating false eyelash has a length;
wherein said length of said label corresponds to said length of said cooperating false eyelash;
wherein said adhesive is for securing said label to a substrate.

2. The device of claim 1 wherein said label further comprises a scale;
wherein said label has a front side and a back side;
wherein said scale is disposed on said front side; and
wherein said adhesive is disposed on said back side.

3. The device of claim 2 wherein said scale has a length corresponding to said length of said cooperating false eyelash and to said length of said label.

4. The device of claim 3 wherein said label further comprises a tab;
wherein said label has a top and a bottom;
wherein said top and said bottom run along said length of said label; and
wherein said tab extends from said top of said label.

5. The device of claim 4 wherein said tab has a length; and wherein said length of said tab is less than said length of said label.

6. The device of claim 5 wherein said adhesive is disposed on said back side of said label, but is not disposed on said tab.

7. The device of claim 6 wherein said tab contains indicia indicating the length of said label.

8. The device of claim 7 wherein said substrate is a tray having at least one protrusion thereon, which protrusion is for displaying said cooperating false eyelash.

9. The device of claim 8 wherein said tray has a cover; and wherein said cover is sufficiently raised above said at least one protrusion so that said tab of said label is not contacted by said cover when said cover is closed.

10. The device of claim 7 wherein said front side of said label is impermeable to fluids.

11. The device of claim 3 wherein said cooperating false eyelash has a shape;
wherein said shape of said cooperating false eyelash is formed by the varying lengths of component lashes of said cooperating false eyelash.

12. The device of claim 1 wherein said label is fabricated out of an opaque material.

13. The device of claim 1 wherein said label is fabricated out of a translucent material.

14. The device of claim 1 wherein said label is fabricated out of a clear transparent material.

15. A method of utilizing a display device wherein said display device comprises:
i) a label; and
ii) an adhesive;
wherein said display device is for displaying a false eyelash;
wherein said display device is for being attached to a cooperating substrate;
wherein said label has a front side and a back side;
wherein said front side of said label has a scale;
wherein said adhesive is on said back side of said label;
wherein said method comprises the steps of:
a) aligning said false eyelash with said scale of said front side of said label;
b) securing said false eyelash to said front side of said label;
c) exposing said adhesive of said label; and
d) adhering said label to said substrate with said adhesive.
